(19) United States
(12) Patent Application Publication
(10) Pub. No.: US 2024/0387835 A1
(43) Pub. Date: Nov. 21, 2024

(54) BIPOLAR PLATE, CELL FRAME, CELL STACK, AND REDOX FLOW BATTERY

(71) Applicants: Sumitomo Electric Industrial, Ltd., Osaka-shi, Osaka (JP); FUKUOKA CLOTH INDUSTRY CO., LTD., Fukuoka-shi, Fukuoka (JP)

(72) Inventors: Takashi KANNO, Osaka-shi (JP); Yamato AMAOKA, Fukuoka-shi (JP); Ryo YOSHIDA, Tokyo (JP)

(73) Assignees: Sumitomo Electric Industrial, Ltd., Osaka-shi, Osaka (JP); FUKUOKA CLOTH INDUSTRRY CO., LTD., Fukuoka-shi, Fukuoka (JP)

(21) Appl. No.: 18/693,747

(22) PCT Filed: Sep. 29, 2021
(86) PCT No.: PCT/JP2021/035909

§ 371 Date: Mar. 20, 2024

(51) Int. Cl. H01M 8/0245; H01M 8/0232; H01M 8/0234; H01M 8/0239; H01M 8/0243; H01M 8/18

(52) U.S. Cl. CPC H01M 8/0245; H01M 8/0232; H01M 8/0234; H01M 8/0239; H01M 8/0243; H01M 8/188

(57) ABSTRACT

A bipolar plate used in a redox flow battery includes a plurality of composite sheets and a first mixture that joins the stacked composite sheets to each other. Each of the plurality of composite sheets includes a resin sheet including a plurality of pores and a second mixture filled in at least some of the plurality of pores in the resin sheet. Each of the first mixture and the second mixture contains a plurality of conductive particles and a resin binder that fixes the plurality of conductive particles to the resin sheet.

### TECHNICAL FIELD

The present disclosure relates to a bipolar plate, a cell frame, a cell stack, and a redox flow battery.

### BACKGROUND ART

In general, a redox flow battery includes a cell stack in which a plurality of battery cells are stacked. The battery cell includes a positive electrode, a negative electrode, and a membrane arranged between the positive electrode and the negative electrode. The cell stack includes a bipolar plate that serves as a partition between adjacent battery cells. PTL 1 discloses a bipolar plate in which carbon felts are stacked. This bipolar plate is a stack in which carbon felts are stacked in a plane direction of the bipolar plate.

### CITATION LIST

### Patent Literature

PTL 1: Japanese Patent Laying-Open No. 11-162496

### SUMMARY OF INVENTION

A bipolar plate in the present disclosure is a bipolar plate used in a redox flow battery, and includes a plurality of composite sheets and a first mixture that joins to each other, the composite sheets that are stacked. Each of the plurality of composite sheets includes a resin sheet including a plurality of pores and a second mixture filled in at least some of the plurality of pores in the resin sheet. Each of the first mixture and the second mixture contains a plurality of conductive particles and a resin binder that fixes the plurality of conductive particles to the resin sheet.

A cell frame in the present disclosure includes the bipolar plate in the present disclosure.

A cell stack in the present disclosure includes the cell frame in the present disclosure.

A redox flow battery in the present disclosure includes the cell stack in the present disclosure.

### BRIEF DESCRIPTION OF DRAWINGS

FIG. 1 is a schematic diagram showing a construction of a redox flow battery according to an embodiment.

FIG. 2 is a schematic diagram showing a construction of a cell stack included in the redox flow battery.

FIG. 3 is a schematic perspective view showing a bipolar plate according to the embodiment.

FIG. 4 is a schematic cross-sectional view showing as being enlarged, a cross-section of the bipolar plate according to the embodiment.

FIG. 5 is a schematic cross-sectional view showing a construction of a composite sheet in the bipolar plate according to the embodiment.

FIG. 6 is a schematic diagram showing as being enlarged, the vicinity of a boundary portion between composite sheets in the bipolar plate according to the embodiment.

FIG. 7 is a schematic cross-sectional view showing as being enlarged, a cross-section of the bipolar plate according to a modification.

FIG. 8 is a schematic cross-sectional view showing a construction of the composite sheet in the bipolar plate according to the modification.

FIG. 9 is a schematic diagram showing as being enlarged, the vicinity of the boundary portion between the composite sheets in the bipolar plate according to the modification.

FIG. 10 is a schematic diagram showing as being enlarged, the vicinity of a surface portion of the bipolar plate according to the modification.

### DETAILED DESCRIPTION

### Problem to be Solved by the Present Disclosure

A bipolar plate excellent in mechanical strength in a redox flow battery has been desired.

A bipolar plate used in a redox flow battery mainly plays a role to electrically connect a positive electrode and a negative electrode of adjacent battery cells to each other and to avoid mixing of an electrolyte between the adjacent battery cells. Therefore, the bipolar plate should have conductivity and such liquid impermeability as being impermeable to the electrolyte. For example, at the time of handling such as manufacturing of a cell frame, bending stress may be applied to the bipolar plate. This bending stress may become a factor for break of the bipolar plate. Therefore, from a point of view of productivity of a component including the bipolar plate, the bipolar plate is required to have mechanical strength high enough to withstand bending stress at the time of handling. Improvement in mechanical strength of the bipolar plate has not conventionally sufficiently been studied.

One of objects of the present disclosure is to provide a bipolar plate excellent in mechanical strength. One of other objects of the present disclosure is to provide a cell frame including the bipolar plate, a cell stack including the cell frame, and a redox flow battery including the cell stack.

### Advantageous Effect of the Present Disclosure

The bipolar plate in the present disclosure is excellent in mechanical strength. The cell frame in the present disclosure, the cell stack in the present disclosure, and the redox flow battery in the present disclosure include the bipolar plate excellent in mechanical strength.

### Description of Embodiments of the Present Disclosure

Embodiments of the present disclosure will initially be listed and described.

(1) A bipolar plate according to an embodiment of the present disclosure is a bipolar plate used in a redox flow battery, and includes a plurality of composite sheets and a first mixture that joins to each other, the composite sheets that are stacked. Each of the plurality of composite sheets includes a resin sheet including a plurality of pores and a second mixture filled in at least some of the plurality of pores in the resin sheet. Each of the first mixture and the second mixture contains a plurality of conductive particles and a resin binder that fixes the plurality of conductive particles to the resin sheet.

The bipolar plate in the present disclosure is integrated by the first mixture, with the plurality of composite sheets being stacked. The bipolar plate in the present disclosure is excellent in mechanical strength, because the resin sheet functions as a reinforcement material. The bipolar plate is higher in mechanical strength than a conventionally used bipolar plate made of plastic carbon. The bipolar plate composed of plastic carbon is a molding of a mixture obtained by mixing carbon particles in resin. The bipolar plate in the present disclosure is in such a structure that the resin sheets are stacked in layers. Therefore, the bipolar plate in the present disclosure is strong against bending in a direction of stack of the composite sheets. The bipolar plate in the present disclosure can achieve suppression of break, for example, due to bending deformation at the time of handling.

The bipolar plate in the present disclosure has conductivity and liquid impermeability. The liquid impermeability refers to such a property of the bipolar plate as being impermeable to an electrolyte. In the bipolar plate in the present disclosure, the plurality of conductive particles contained in the second mixture are held as being dispersed in the inside of the resin sheet. Therefore, the bipolar plate in the present disclosure can have ensured conductivity. The bipolar plate in the present disclosure is less likely to be provided with such a pore as communicating in the direction of stack of the composite sheet, owing to stacking of the plurality of composite sheets. As the resin sheet is filled with the second mixture, the resin sheet is provided with few pores. Therefore, the bipolar plate in the present disclosure can have ensured liquid impermeability to the electrolyte.

(2) In one form of the bipolar plate, a mass ratio of the resin sheet may be not lower than 3 mass % and not higher than 15 mass %.

The form above tends to ensure mechanical strength and conductivity of the bipolar plate.

(3) In one form of the bipolar plate, the first mixture is arranged between the resin sheets of adjacent composite sheets.

In the form above, the first mixture facilitates joint of adjacent composite sheets to each other.

(4) In one form of the bipolar plate, a third mixture that makes up a surface of the bipolar plate is provided. The third mixture contains a plurality of conductive particles and a resin binder that fixes the plurality of conductive particles to the resin sheet.

In the form above, the surface of the bipolar plate is composed of the third mixture, so that conductivity of the surface of the bipolar plate is improved.

(5) In one form of the bipolar plate, the resin sheet includes a plurality of resin fibers.

The resin sheet including the plurality of resin fibers include a pore between fibers. In the form above, the pore between the fibers is filled with the second mixture.

(6) In one form of the bipolar plate described in (5), the resin sheet may be a nonwoven fabric or a woven fabric.

In the form above, with increase in second mixture filled in the pore between the fibers, conductivity of the bipolar plate can be enhanced.

(7) In one form of the bipolar plate described in (5) or (6), the plurality of resin fibers include polypropylene fibers.

The form above can achieve enhanced mechanical strength of the bipolar plate.

(8) In one form of the bipolar plate, at least seven composite sheets may be stacked.

The form above tends to ensure mechanical strength and liquid impermeability of the bipolar plate.

(9) In one form of the bipolar plate, the resin sheet may have a thickness not smaller than 0.1 mm and not larger than 2 mm.

The form above tends to realize reduction in thickness of the bipolar plate while mechanical strength and liquid impermeability of the bipolar plate are ensured.

(10) In one form of the bipolar plate, the bipolar plate may have a thickness not smaller than 2 mm and not larger than 10 mm.

The form above can achieve reduction in thickness of the bipolar plate while mechanical strength and liquid impermeability of the bipolar plate are ensured.

(11) In one form of the bipolar plate, the bipolar plate may have bending strength not lower than 0.5 MPa.

The form above is strong against bending and the bipolar plate is less likely to break.

(12) A cell frame according to the embodiment of the present disclosure includes the bipolar plate described in any one of (1) to (11).

The cell frame in the present disclosure includes the bipolar plate excellent in mechanical strength. Since the bipolar plate is less likely to break at the time of manufacturing of the cell frame, the cell frame in the present disclosure is excellent in productivity.

(13) A cell stack according to the embodiment of the present disclosure includes the cell frame described in (12).

Since the cell stack in the present disclosure includes the cell frame in the present disclosure described above, it includes the bipolar plate excellent in mechanical strength. Since the bipolar plate is less likely to break at the time of manufacturing of the cell stack, the cell stack in the present disclosure is excellent in productivity.

(14) A redox flow battery according to the embodiment of the present disclosure includes the cell stack described in (13).

Since the redox flow battery in the present disclosure includes the cell stack in the present disclosure described above, it includes the bipolar plate excellent in mechanical strength. Since the bipolar plate is less likely to break at the time of assembly of the redox flow battery, the redox flow battery in the present disclosure is excellent in productivity.

### Details of Embodiments of the Present Disclosure

A specific example of the bipolar plate, the cell frame, the cell stack, and the redox flow battery in the present disclosure will be described with reference to the drawings. A redox flow battery may be called an “RF battery” below. The same or corresponding elements in the drawings have the same reference characters allotted.

The present invention is not limited to such illustrations but defined by the terms of the claims, and is intended to include any modifications within the scope and meaning equivalent to the terms of the claims.

The RF battery, the cell stack, and the cell frame will be described first below and thereafter the bipolar plate will be described in detail.

### <RF Battery>

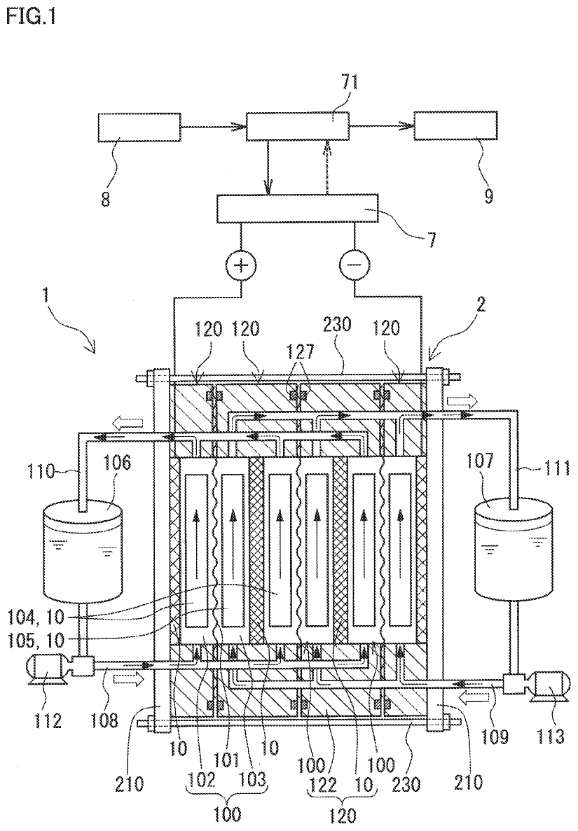

An RF battery 1 will be described with reference to FIG. 1. RF battery 1 is representatively connected to a power generator 8 and a load 9 with an alternating-current (AC)/direct-current (DC) converter 7 and a transformer facility 71 being interposed. RF battery 1 can be charged with electric power generated by power generator 8 or can discharge charged electric power to load 9. Power generator 8 refers to a power generation facility that uses natural energy such as photovoltaic power generation or wind power generation or another general power plant. RF battery 1 is used, for example, for a load leveling application, instantaneous voltage drop compensation, an application for an emergency power supply, or an application for smoothening of output in natural energy power generation.

RF battery 1 is charged and discharged by circulation of an electrolyte in a battery cell 100. RF battery 1 includes battery cell 100, a tank where the electrolyte is stored, and a circulation flow channel through which the electrolyte circulates between battery cell 100 and the tank. The tank includes a positive electrolyte tank 106 where a positive electrolyte is stored and a negative electrolyte tank 107 where a negative electrolyte is stored. The circulation flow channel includes piping that connects battery cell 100 and each tank to each other.

For example, a vanadium-based electrolyte, a titanium-manganese-based electrolyte, or the like is employed as the electrolyte. Both of the positive electrolyte and the negative electrolyte of the vanadium-based electrolyte contain vanadium ions as an active material. The positive electrolyte of the titanium-manganese-based electrolyte contains manganese ions as the active material and the negative electrolyte thereof contains titanium ions as the active material.

### (Battery Cell)

Battery cell 100 includes a positive electrode 104, a negative electrode 105, and a membrane 101. Membrane 101 is arranged between positive electrode 104 and negative electrode 105. Battery cell 100 is divided into a positive cell 102 and a negative cell 103 by membrane 101. Positive electrode 104 is arranged in positive cell 102. Negative electrode 105 is arranged in negative cell 103.

Positive cell 102 is supplied with the positive electrolyte. Negative cell 103 is supplied with the negative electrolyte. As shown in FIG. 1, RF battery 1 includes a supply pipe 108 and a return pipe 110 that connect battery cell 100 and positive electrolyte tank 106 to each other. RF battery 1 includes a supply pipe 109 and a return pipe 111 that connect battery cell 100 and negative electrolyte tank 107 to each other. Supply pipes 108 and 109 are provided with respective pumps 112 and 113. The positive electrolyte is supplied by pump 112 from positive electrolyte tank 106 through supply pipe 108 to positive cell 102. The positive electrolyte that has passed through positive cell 102 and is discharged from positive cell 102 returns to positive electrolyte tank 106 through return pipe 110. In other words, supply pipe 108 and return pipe 110 form the circulation flow channel of the positive electrolyte. The negative electrolyte is supplied by pump 113 from negative electrolyte tank 107 through supply pipe 109 to negative cell 103. The negative electrolyte that has passed through negative cell 103 and is discharged from negative cell 103 returns to negative electrolyte tank 107 through return pipe 111. In other words, supply pipe 109 and return pipe 111 form the circulation flow channel of the negative electrolyte.

### <Cell Stack>

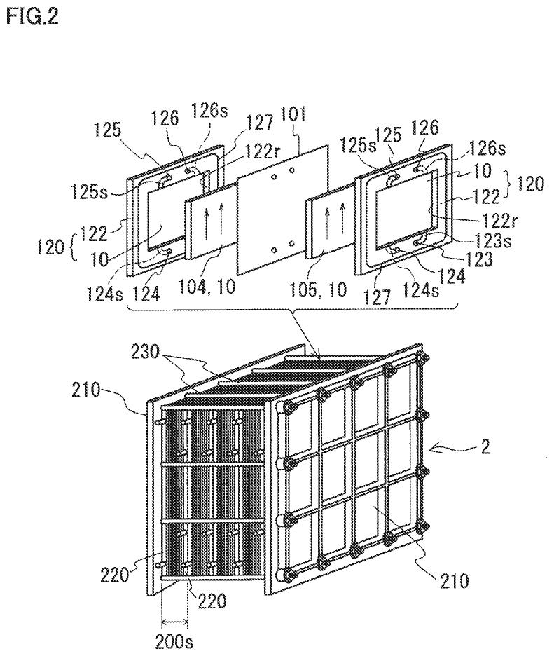

RF battery 1 includes a cell stack 2. Cell stack 2 is in a structure in which a plurality of battery cells 100 are stacked. For example, as shown in FIG. 2, cell stack 2 is constructed by sandwiching a sub stack 200s between two end plates 210 from opposing sides thereof and fastening the sub stack with a fastening mechanism 230. FIG. 2 shows cell stack 2 including a plurality of sub stacks 200s. Sub stack 200s includes a stack and a supply/drainage plate 220 provided on each of opposing ends of the stack. The stack is repeatedly stacked in the order of a cell frame 120, positive electrode 104, membrane 101, and negative electrode 105. Supply pipes 108 and 109 and return pipes 110 and 111 shown in FIG. 1 described above are connected to supply/drainage plate 220. The number of stacked battery cells 100 in cell stack 2 can be selected as appropriate.

### <Cell Frame>

Cell frame 120 includes a bipolar plate 10. Cell frame 120 in the present embodiment includes bipolar plate 10 and a frame body 122 provided around an outer periphery of bipolar plate 10. As shown in FIG. 1, bipolar plate 10 serves as a partition between adjacent battery cells 100. Bipolar plate 10 is arranged between positive electrode 104 and negative electrode 105 of adjacent battery cells 100. A surface of bipolar plate 10 includes a first surface that faces positive electrode 104 and a second surface that faces negative electrode 105. As shown in FIG. 2, frame body 122 is provided around the outer periphery of bipolar plate 10. On an inner side of frame body 122, the surface of bipolar plate 10 and an inner peripheral surface of frame body 122 define a recess 122r. Recess 122r is provided on each of opposing sides of bipolar plate 10. Positive electrode 104 is arranged in recess 122r on a side of the first surface of bipolar plate 10. Negative electrode 105 is arranged in recess 122r on a side of the second surface of bipolar plate 10. Recesses 122r define cell spaces in positive cell 102 and negative cell 103 shown in FIG. 1 described above, respectively.

Resin is adopted as a material for frame body 122. The resin that makes up frame body 122 is, for example, polyvinyl chloride (PVC), polypropylene (PP), polyethylene (PE), or a fluorine resin. Examples of the fluorine resin include polytetrafluoroethylene (PTFE). Frame body 122 is formed, for example, by injection molding of resin around the outer periphery of bipolar plate 10.

As shown in FIG. 1, in cell stack 2, a single battery cell 100 is provided between bipolar plates 10 of adjacent cell frames 120. A surrounding sealing member 127 that suppresses leakage of the electrolyte is arranged between frame bodies 122 of cell frames 120. For example, an O ring is employed as sealing member 127.

As shown in FIG. 2, frame body 122 of cell frame 120 includes liquid supply manifolds 123 and 124 and liquid discharge manifolds 125 and 126. In the present example, the positive electrolyte is supplied from liquid supply manifold 123 through a liquid supply slit 123s to positive electrode 104. The positive electrolyte supplied to positive electrode 104 is discharged to liquid discharge manifold 125 through a liquid discharge slit 125s. Similarly, the negative electrolyte is supplied from liquid supply manifold 124 through a liquid supply slit 124s to negative electrode 105. The negative electrolyte supplied to negative electrode 105 is discharged to liquid discharge manifold 126 through a liquid discharge slit 126s. Liquid supply manifolds 123 and 124 and liquid discharge manifolds 125 and 126 are formed to penetrate frame body 122. Liquid supply manifolds 123 and 124 and liquid discharge manifolds 125 and 126 define flow channels of the electrolytes as cell frames 120 are stacked. Each of the flow channels is connected to supply pipes 108 and 109 and return pipes 110 and 111 shown in FIG. 1 through supply/drainage plate 220. In cell stack 2, the positive electrolyte and the negative electrolyte can flow to battery cells 100 through the flow channels.

### <Bipolar Plate>

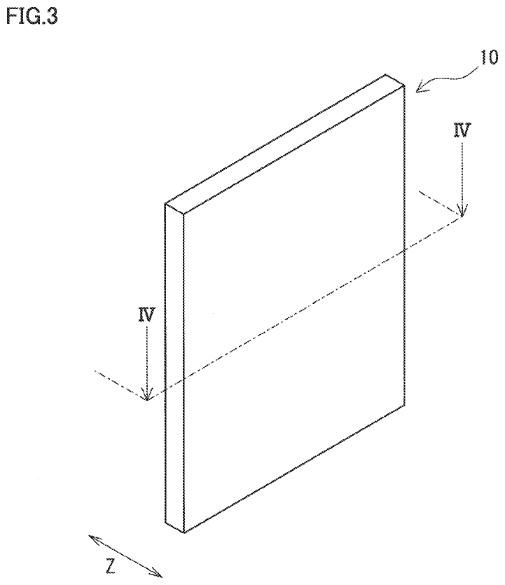

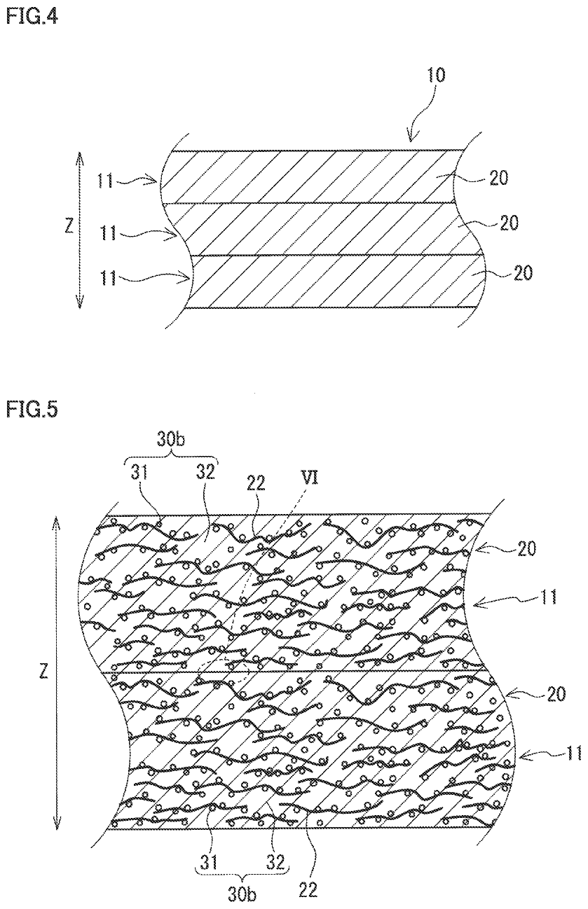

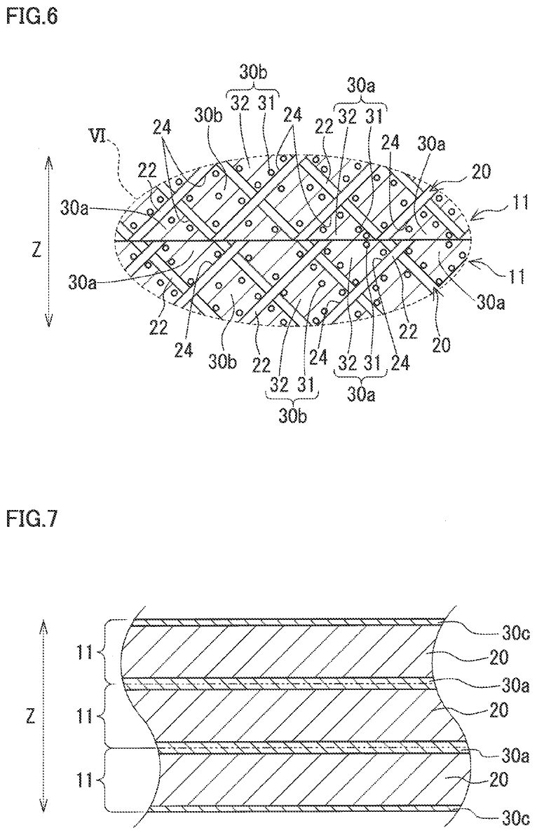

Bipolar plate 10 according to the embodiment will be described with reference to FIGS. 3 to 6. One of characteristics of bipolar plate 10 according to the embodiment resides in a structure in which a plurality of composite sheets 11 are stacked as shown in FIG. 4. Bipolar plate 10 includes the plurality of composite sheets 11 shown in FIG. 5 and a first mixture 30a shown in FIG. 6. First mixture 30a joins stacked composite sheets 11 to each other. As shown in FIG. 6, each of the plurality of composite sheets 11 includes a resin sheet 20 and a second mixture 30b. As shown in FIG. 6, resin sheet 20 includes a plurality of pores 24. At least some of the plurality of pores 24 in resin sheet 20 are filled with second mixture 30b. Each of first mixture 30a and second mixture 30b contains a plurality of conductive particles 31 and a resin binder 32.

FIG. 4 shows a part of a cross-section along IV-IV in FIG. 3. The cross-section of bipolar plate 10 shown in FIG. 4 is the cross-section cut along a direction of thickness of bipolar plate 10. The direction of thickness of bipolar plate 10 is a direction orthogonal to the surface of bipolar plate 10. The direction of thickness of bipolar plate 10 corresponds to the direction of stack of composite sheets 11. FIG. 5 shows the cross-section of adjacent composite sheets 11 as being enlarged. FIG. 6 shows as being enlarged, a portion surrounded by the line VI in FIG. 5. FIGS. 5 and 6 show resin binder 32 with hatching for the sake of convenience. FIGS. 5 and 6 schematically show the construction of resin sheet 20, a shape and a size of pore 24, and the construction of first mixture 30a and second mixture 30b in a simplified manner. An arrow Z in the figures indicates the direction of thickness.

Bipolar plate 10 is excellent in mechanical strength because resin sheet 20 functions as a reinforcement material. Bipolar plate 10 has conductivity and such liquid impermeability as being impermeable to the electrolyte.

A shape of bipolar plate 10 can be selected as appropriate. In the present example, bipolar plate 10 is rectangular in a plan view. Bipolar plate 10 has a thickness, for example, not smaller than 2 mm and not larger than 10 mm. As bipolar plate 10 is larger in thickness, mechanical strength of bipolar plate 10 improves. As bipolar plate 10 is larger in thickness, a pore that communicates in the direction of thickness of bipolar plate 10, that is, the direction of stack of composite sheets 11, is less likely to be provided. Therefore, liquid impermeability of bipolar plate 10 improves. When bipolar plate 10 has a thickness not smaller than 2 mm, bipolar plate 10 tends to have ensured mechanical strength and liquid impermeability. When bipolar plate 10 has a thickness not larger than 10 mm, bipolar plate 10 can be reduced in thickness. As bipolar plate 10 is reduced in thickness, cell stack 2 can be reduced in size and thus RF battery 1 can be reduced in size. As bipolar plate 10 is smaller in thickness, an electrical resistance of bipolar plate 10 is lower. Furthermore, bipolar plate 10 may have a thickness not smaller than 4 mm and not larger than 8 mm.

Bipolar plate 10 has bending strength, for example, not lower than 0.5 MPa. When the bending strength of bipolar plate 10 is not lower than 0.5 MPa, bipolar plate 10 is strong against bending and less likely to break. The bending strength is measured in a three-point bending test. Bipolar plate 10 has the bending strength, for example, preferably not lower than 0.8 MPa or not lower than 1.0 MPa. Furthermore, bipolar plate 10 may have the bending strength not lower than 2 MPa or not lower than 5 MPa. An upper limit of the bending strength of bipolar plate 10 is practically, for example, 40 MPa. In other words, bipolar plate 10 has the bending strength, for example, not lower than 0.5 MPa and not higher than 40 MPa.

Bipolar plate 10 has tensile strength, for example, not lower than 2 MPa. When bipolar plate 10 has the tensile strength not lower than 2 MPa, it has sufficient tensile strength.

Furthermore, bipolar plate 10 may have the tensile strength not lower than 6 MPa or not lower than 20 MPa. An upper limit of the tensile strength of bipolar plate 10 is practically, for example, 40 MPa. In other words, bipolar plate 10 has the tensile strength, for example, not lower than 2 MPa and not higher than 40 MPa.

Bipolar plate 10 has a volume resistivity, for example, not higher than 2.0 Ω·cm. When bipolar plate 10 has the volume resistivity not higher than 2.0 Ω·cm, it has good conductivity. Bipolar plate 10 has the volume resistivity, for example, preferably not higher than 1.5 Ω·cm or not higher than 1.0 Ω·cm. Furthermore, bipolar plate 10 may have the volume resistivity not higher than 0.5 Ω·cm, not higher than 0.3 Ω·cm, or not higher than 0.2 Ω·cm. A lower limit of the volume resistivity of bipolar plate 10 is, for example, 0.05 Ω·cm. In other words, bipolar plate 10 has the volume resistivity, for example, not lower than 0.05 Ω·cm and not higher than 2.0 Ω·cm. The volume resistivity is a volume resistivity in a plane direction of the bipolar plate. The plane direction of the bipolar plate refers to a direction orthogonal to the direction of thickness of the bipolar plate.

### (Composite Sheet)

As shown in FIG. 6, composite sheet 11 contains second mixture 30b filled in pores 24 in resin sheet 20. In resin sheet 20, at least some of the plurality of pores 24 are filled with second mixture 30b. Therefore, resin sheet 20 includes few pores 24 not filled with second mixture 30b. In the present example, substantially all of pores 24 in resin sheet 20 are filled with second mixture 30b. In other words, the entirety of the inside of resin sheet 20 is substantially filled with second mixture 30b. The plurality of conductive particles 31 contained in second mixture 30b are held as being dispersed in the inside of resin sheet 20, so that conductivity of bipolar plate 10 can be ensured.

As shown in FIG. 4, the plurality of composite sheets 11 are stacked, so that such a pore 24 (see FIG. 6) as communicating in the direction of stack of composite sheets 11 is less likely to be provided. Consequently, liquid impermeability of bipolar plate 10 can be ensured. The number of stacked composite sheets 11 can be selected as appropriate. In FIG. 4, three composite sheets 11 are stacked for the sake of convenience of description. For example, at least seven composite sheets 11 are stacked. The number of stacked composite sheets 11 is the same as the number of resin sheets 20. As the number of stacked composite sheets 11 is larger, the number of resin sheets 20 increases. Therefore, mechanical strength of bipolar plate 10 can be enhanced. As the number of stacked composite sheets 11 is larger, such a pore 24 as communicating in the direction of stack of composite sheets 11 is less likely to be provided. Therefore, liquid impermeability is improved. When at least seven composite sheets 11 are stacked, the mechanical strength and the liquid impermeability of bipolar plate 10 are readily ensured. An upper limit of the number of stacked composite sheets 11 is set, for example, to eighty. When at most eighty composite sheets 11 are stacked, bipolar plate 10 can be reduced in thickness. Furthermore, the number of stacked composite sheets 11 may be not smaller than fifteen and not larger than sixty or not smaller than twenty and not larger than fifty.

### (Resin Sheet)

Resin sheet 20 is a sheet composed of resin. Resin sheet 20 has a three-dimensional structure including the plurality of pores 24 (see FIG. 6). Pores 24 include open pores continuous from a surface to the inside of resin sheet 20. The open pore is a pore contiguous from the inside to the outside of resin sheet 20. Furthermore, pore 24 may include a closed pore that does not open in the surface of resin sheet 20 but is isolated in resin sheet 20. The closed pore is a pore present in the inside of resin sheet 20 and not contiguous to the outside. Any form such as a fiber aggregate or a sponge may be applicable as the form of resin sheet 20. A known resin sheet can be employed as resin sheet 20. The fiber aggregate will be described later.

Resin sheet 20 is preferably resistant to the electrolyte and excellent in mechanical characteristics. Resin sheet 20 is composed, for example, of PP, PE, PTFE, or polyamide (PA). Polyamide includes aramid. From a point of view of mechanical characteristics, resistance to the electrolyte, cost, or the like, among these resins, PP is preferred.

A mass ratio of resin sheet 20 is, for example, not lower than 3 mass % and not higher than 15 mass %. As the mass ratio of resin sheet 20 is higher, the mechanical strength of bipolar plate 10 improves. When the mass ratio of resin sheet 20 is not lower than 3 mass %, the mechanical strength of bipolar plate 10 is readily ensured. As the mass ratio of resin sheet 20 is higher, an electrical resistance of bipolar plate 10 becomes higher. When the mass ratio of resin sheet 20 is not higher than 15 mass %, the electrical resistance of bipolar plate 10 can be lowered. Furthermore, the mass ratio of resin sheet 20 may be not lower than 7 mass % and not higher than 9.5 mass %.

The mass ratio of resin sheet 20 refers to a ratio of the mass of resin sheet 20 with the mass of the entire bipolar plate 10 being defined as 100%. The mass ratio of resin sheet 20 is expressed as [(Ma/M)×100], where M represents the mass of bipolar plate 10 and Ma represents the mass of resin sheet 20. The mass of resin sheet 20 is the mass with first mixture 30a and second mixture 30b being excluded from composite sheet 11. The mass of resin sheet 20 can be measured, for example, as below. Bipolar plate 10 is immersed in a solvent to dissolve resin binder 32 contained in each mixture with the solvent. A solvent that dissolves resin binder 32 but does not dissolve resin sheet 20 is selected as the solvent. For example, toluene, xylene, ester, benzene, or the like can be employed as the solvent. After the resin binder 32 is dissolved, resin sheet 20 is cleaned. As resin sheet 20 is cleaned, conductive particles 31 that adhere to resin sheet 20 are washed away. After resin sheet 20 is dried, the mass of resin sheet 20 is measured.

Resin sheet 20 has a thickness, for example, not smaller than 0.1 mm and not larger than 2 mm. As resin sheet 20 has a larger thickness, the mechanical strength of bipolar plate 10 improves. As resin sheet 20 has a larger thickness, such a pore 24 (see FIG. 6) as communicating in the direction of thickness of resin sheet 20 is less likely to be provided. Therefore, liquid impermeability improves. When resin sheet 20 has a thickness not smaller than 0.1 mm, the mechanical strength and the liquid impermeability of bipolar plate 10 are readily ensured. When resin sheet 20 has a thickness not larger than 2 mm, bipolar plate 10 can be reduced in thickness. Furthermore, resin sheet 20 may have a thickness not smaller than 0.15 mm and not larger than 1 mm. The thickness of resin sheet 20 here refers to the thickness while resin sheet 20 is not compressed.

Resin sheet 20 has a porosity, for example, not lower than 20 volume % and not higher than 95 volume %. As resin sheet 20 has a higher porosity, a fill factor of second mixture 30b to be filled in the inside of resin sheet 20 can be higher. In other words, the mass ratio of conductive particles 31 increases. Consequently, the conductivity of bipolar plate 10 improves. With the porosity of resin sheet 20 being not lower than 20 volume %, the conductivity of bipolar plate 10 can be enhanced. As the porosity of resin sheet 20 is higher, the mechanical strength of resin sheet 20 lowers. In other words, the mechanical strength of bipolar plate 10 lowers. With the porosity of resin sheet 20 being not higher than 95 volume %, the mechanical strength of bipolar plate 10 tends to be ensured. Furthermore, the porosity of resin sheet 20 may be not lower than 30 volume % and not higher than 90 volume %.

The porosity of resin sheet 20 refers to a ratio of a volume of pores, with an apparent volume of resin sheet 20 being defined as 100%. The porosity of resin sheet 20 is expressed as [(Vp/V)×100], where V represents the apparent volume of resin sheet 20 and Vp represents the volume of the pores. The apparent volume refers to the volume of resin sheet 20 including the pores. The porosity of resin sheet 20 can be measured, for example, based on the Archimedes' principle. The porosity of resin sheet 20 is measured by using the solvent described above to remove each mixture from resin sheet 20.

### <Fiber Aggregate>

In the present example, as shown in FIG. 5, resin sheet 20 is made from a fiber aggregate including a plurality of resin fibers 22. The fiber aggregate is a sheet composed of the plurality of resin fibers 22. As shown in FIG. 6, the fiber aggregate include pores 24 among resin fibers 22. These pores 24 are filled with second mixture 30b. In other words, in an example where resin sheet 20 is made from the fiber aggregate, pores 24 among resin fibers 22 are filled with second mixture 30b so that the plurality of conductive particles 31 are held in the inside of the fiber aggregate.

Examples of the fiber aggregate include a nonwoven fabric, a woven fabric, and paper. The shape of the nonwoven fabric and the woven fabric is maintained by the plurality of intertwined resin fibers 22. The shape of paper is maintained by the plurality of bonded resin fibers 22. The nonwoven fabric is made up of interlaced independent and individual resin fibers 22. The woven fabric is made up of woven yarns of twisted resin fibers 22. The nonwoven fabric or the woven fabric include a larger number of pores among resin fibers 22 than paper containing a binder that binds resin fibers 22 to one another. Therefore, the nonwoven fabric or the woven fabric is relatively high in porosity. When resin sheet 20 is made from the nonwoven fabric or the woven fabric, second mixture 30b filled in the inside of resin sheet 20 tends to be large in amount. Consequently, the mass ratio of conductive particles 31 can be increased. In particular, the nonwoven fabric is more advantageous than the woven fabric in that micropores are uniformly distributed among resin fibers 22. A known fiber aggregate can be employed as the fiber aggregate.

For example, fibers of PP, PE, PTFE, or PA are employed as resin fibers 22. PP fibers are preferred as resin fibers 22 from a point of view of mechanical characteristics, resistance to the electrolyte, cost, or the like. The fiber aggregate containing PP fibers tends to have ensured mechanical strength.

Resin fibers 22 have an average diameter, for example, not smaller than 5 μp and not larger than 50 μm. With the average diameter of resin fibers 22 being not smaller than 5 μm, the mechanical strength of the fiber aggregate is readily ensured. With the average diameter of resin fibers 22 being not larger than 50 82 m, resin fibers 22 can have appropriate flexibility. Therefore, the fiber aggregate has good flexibility. Furthermore, resin fibers 22 may have the average diameter not smaller than 10 μm and not larger than 40 μm.

The average diameter of resin fibers 22 can be measured, for example, as below. A cross-section of the fiber aggregate is observed with a scanning electronic microscope (SEM). An area of the cross-sections of resin fibers 22 is calculated by image analysis of an SEM image. The cross-section of resin fiber 22 is a cross-section orthogonal to a longitudinal direction of resin fiber 22. A diameter of a circle having an area equal to the cross-sectional area of resin fiber 22 is defined as the diameter of resin fiber 22. For example, an average value of diameters of at least ten resin fibers 22 is adopted as the average diameter of resin fibers 22. Furthermore, at least twenty or at least thirty resin fibers 22 may be subjected to measurement. An acceleration voltage of the SEM for observation is, for example, not lower than 10 kV and not higher than 20 kV. A magnification of the SEM for observation is, for example, not lower than 100× and not higher than 500×.

### (Mixture)

As shown in FIG. 6, each of first mixture 30a and second mixture 30b is a mixture containing a plurality of conductive particles 31 and resin binder 32. First mixture 30a joins adjacent composite sheets 11 to each other. Resin binder 32 contained in first mixture 30a functions as an adhesive that joins composite sheets 11 to each other. In the present example, first mixture 30a and second mixture 30b are the same mixture. When first mixture 30a and second mixture 30b are the same, a material for conductive particles 31 and a material for resin binder 32 contained in first mixture 30a are the same as a material for conductive particles 31 and a material for resin binder 32 contained in second mixture 30b, respectively. When first mixture 30a and second mixture 30b are the same, a content of conductive particles 31 and a content of resin binder 32 in first mixture 30a are substantially the same as a content of conductive particles 31 and a content of resin binder 32 in second mixture 30b, respectively. The contents of conductive particles 31 substantially being the same means that a ratio between the content of conductive particles 31 in first mixture 30a and the content of conductive particles 31 in second mixture 30b is within a range not smaller than 0.9 and not larger than 1.1. The contents of resin binder 32 substantially being the same means that a ratio between the content of resin binder 32 in first mixture 30a and the content of resin binder 32 in second mixture 30b is within a range not smaller than 0.9 and not larger than 1.1. In the present example, adjacent composite sheets 11 are in contact with each other. First mixture 30a is a portion that defines a boundary between adjacent composite sheets 11, among second mixtures 30b filled in pores 24 in each resin sheet 20. In other words, some of second mixtures 30b filled in pores 24 that open in the surface of resin sheet 20 also serve as first mixture 30a.

### <Conductive Particles>

Conductive particles 31 have conductivity and prescribed resistance to the electrolyte. Conductive particles 31 are, for example, carbon particles or metal particles. Carbon that makes up carbon particles is, for example, graphite or carbon black. Metal that makes up the metal particles is, for example, a metal selected from the group consisting of gold, silver, copper, tin, iron, nickel, chromium, zinc, aluminum, and titanium or an alloy thereof. From a point of view of the conductivity, resistance to the electrolyte, cost, or the like, carbon particles are preferred as conductive particles 31.

A state of conductive particles 31 dispersed in the inside of resin sheet 20 is held by resin binder 32. Conductive particle 31 representatively has a spherical shape. Conductive particle 31 may be in a shape of a needle or a thin plate, other than the spherical shape. Conductive particles 31 have an average particle size, for example, not smaller than 20 nm and not larger than 100 μm. The average particle size of conductive particles 31 is preferably smaller than an average pore diameter of resin sheet 20. The average pore diameter of resin sheet 20 can be measured, for example, with mercury porosimetry. The average pore diameter of resin sheet 20 is measured by using the solvent described above to remove each mixture from resin sheet 20.

The average particle size of conductive particles 31 can be measured, for example, as below. A cross-section of composite sheet 11 is observed with the SEM. An area of cross-sections of conductive particles 31 is calculated by image analysis of an SEM image. A diameter of a circle having an area equal to the cross-sectional area of conductive particle 31 is defined as the particle size of conductive particle 31. For example, an average value of the particle sizes of at least twenty conductive particles 31 is adopted as the average particle size of conductive particles 31. Furthermore, at least fifty or at least one hundred conductive particles 31 may be subjected to measurement. An acceleration voltage of the SEM for observation is, for example, not lower than 10 kV and not higher than 20 kV. A magnification of the SEM for observation is, for example, not lower than 100× and not higher than 500×.

The mass ratio of conductive particles 31 is, for example, not lower than 55 mass % and not higher than 95 mass %. As the mass ratio of conductive particles 31 is higher, the conductivity of bipolar plate 10 improves. With the mass ratio of conductive particles 31 being not lower than 55 mass %, the conductivity of bipolar plate 10 is readily ensured. As the mass ratio of conductive particles 31 is higher, the ratio of resin binder 32 tends to lower. With the mass ratio of conductive particles 31 being not higher than 95 mass %, decrease in resin binder 32 can be suppressed. Furthermore, the mass ratio of conductive particles 31 may be not lower than 60 mass % and not higher than 85 mass % or not lower than 60 mass % and not higher than 70 mass %. The mass ratio of conductive particles 31 refers to a ratio of the mass of conductive particles 31 with the mass of the entire bipolar plate 10 being defined as 100%. The mass ratio of conductive particles 31 is expressed as [(Mb/M)×100], where M represents the mass of bipolar plate 10 and Mb represents the mass of conductive particles 31. The mass of conductive particles 31 is measured, for example, as below. The solvent described above is used to dissolve resin binder 32 contained in each mixture. The mass of conductive particles 31 separated from resin sheet 20 is measured.

### <Resin Binder>

Resin binder 32 fixes the plurality of conductive particles 31 to resin sheet 20. Resin binder 32 is composed, for example, of resin such as PE, PP, chlorinated polyolefin, PTFE, perfluoroalkoxy alkane (PFA), a perfluoroethylene propene copolymer (FEP), or polyphenylene sulfide (PPS). Resin binder 32 may be the same as or different from the resin that makes up resin sheet 20. From a point of view of manufacturing, resin binder 32 is preferably lower in softening point than resin sheet 20. The reason therefor will be described later.

The mass ratio of resin binder 32 is, for example, not lower than 5 mass % and not higher than 40 mass %. With the mass ratio of resin binder 32 being not lower than 5 mass %, conductive particles 31 are readily fixed to resin sheet 20 with resin binder 32. With the mass ratio of resin binder 32 being not higher than 40 mass %, the ratio of conductive particles 31 can be high. Consequently, the conductivity of bipolar plate 10 improves. Furthermore, the mass ratio of resin binder 32 may be not lower than 10 mass % and not higher than 30 mass % or not lower than 20 mass % and not higher than 30 mass %. The mass ratio of resin binder 32 refers to the ratio of the mass of resin binder 32 with the mass of the entire bipolar plate 10 being defined as 100%. The mass ratio of resin binder 32 is expressed as [(Mc/M)×100], where M represents the mass of bipolar plate 10 and Mc represents the mass of resin binder 32. The mass ratio of resin binder 32 can be calculated, for example, by subtracting the mass ratio of resin sheet 20 and the mass ratio of conductive particles 31 described above from 100%.

### Modification

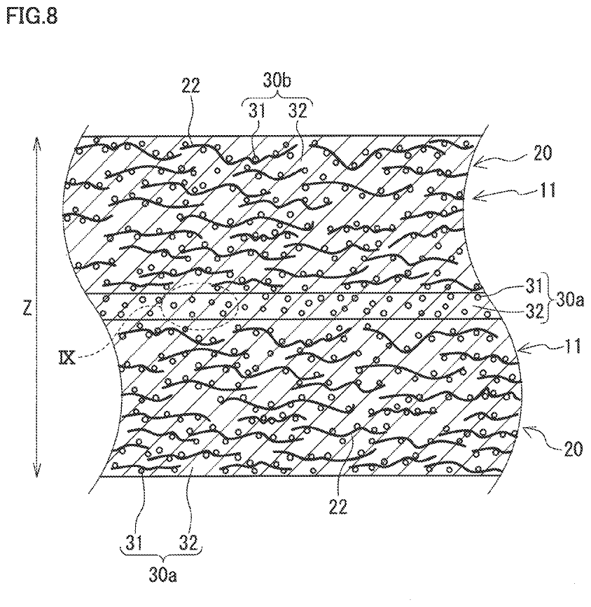

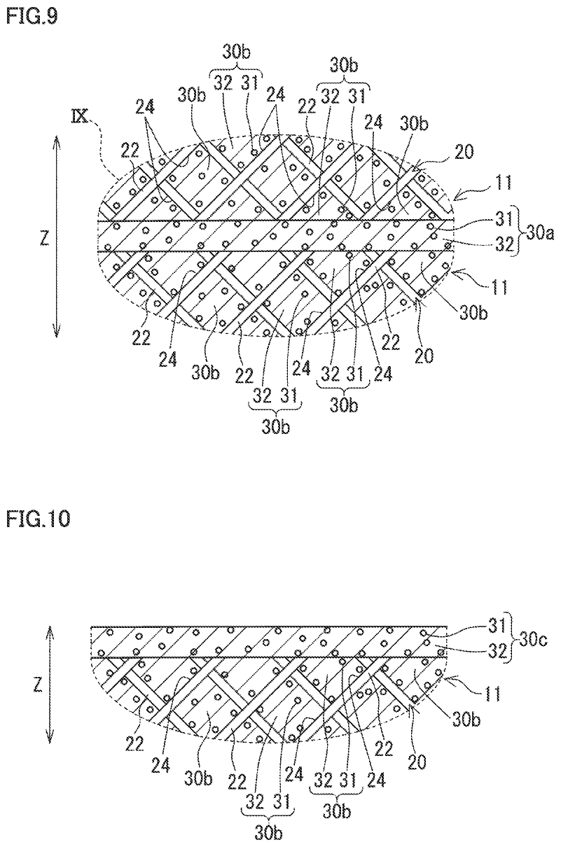

A modification of bipolar plate 10 will be described with reference to FIGS. 7 to 10. FIG. 7 shows a part of the cross-section of bipolar plate 10 as in FIG. 4. FIG. 8 shows as being enlarged, a cross-section of adjacent composite sheets 11 as in FIG. 5. FIG. 9 shows as being enlarged, a portion surrounded by the line IX in FIG. 8. FIG. 10 shows as being enlarged, a cross-section of a surface portion of bipolar plate 10. FIGS. 8 to 10 show resin binder 32 with hatching for the sake of convenience. FIGS. 8 to 10 schematically show the construction of resin sheet 20, the shape and the size of pore 24, and the construction of first mixture 30a and second mixture 30b in a simplified manner. Bipolar plate 10 according to the modification is different from that in the embodiment described above in including first mixture 30a between resin sheets 20 of adjacent composite sheets 11. A difference of bipolar plate 10 in the modification from that in the embodiment described above will mainly be described, and description of similar matters will not be given.

### (First Mixture 30a)

As shown in FIGS. 7 and 8, first mixture 30a is arranged between resin sheets 20 of adjacent composite sheets 11. First mixture 30a is formed in layers, of a mixture containing the plurality of conductive particles 31 and resin binder 32. As shown in FIG. 9, first mixture 30a is not filled in pores 24 in resin sheet 20 but exposed at the surface of resin sheet 20. Adjacent composite sheets 11 are not in contact with each other but are joined to each other with first mixture 30a being interposed. When first mixture 30a is arranged between resin sheets 20, an amount of the mixture contained in bipolar plate 10 is large. First mixture 30a may be the same as or different from second mixture 30b. When first mixture 30a is different from second mixture 30b, for example, a material for conductive particles 31 contained in first mixture 30a may be different from a material for conductive particles 31 contained in second mixture 30b. When first mixture 30a and second mixture 30b are different from each other, for example, the material for resin binder 32 contained in first mixture 30a may be different from the material for resin binder 32 contained in second mixture 30b. In the modification, first mixture 30a and second mixture 30b are the same mixture. In other words, the material for conductive particles 31 and the material for resin binder 32 contained in first mixture 30a are the same as the material for conductive particles 31 and the material for resin binder 32 contained in second mixture 30b, respectively. In addition, the content of conductive particles 31 in first mixture 30a is substantially the same as the content of conductive particles 31 in second mixture 30b. The content of resin binder 32 in first mixture 30a is substantially the same as the content of resin binder 32 in second mixture 30b.

In the modification, first mixture 30a functions as an adhesive layer that joins composite sheets 11 to each other. First mixture 30a has a thickness, for example, not smaller than 5 μm and not larger than 300 μm. The thickness of first mixture 30a is a distance between resin sheets 20 of adjacent composite sheets 11, that is, a distance between surfaces of resin sheets 20 opposed to each other. With the thickness of first mixture 30a being not smaller than 5 μm, first mixture 30a tends to sufficiently function as the adhesive layer. With the thickness of first mixture 30a being not larger than 300 μm, bipolar plate 10 can be reduced in thickness. Furthermore, first mixture 30a may have a thickness not smaller than 10 μm and not larger than 250 μm.

Furthermore, in the modification, as shown in FIG. 7, a third mixture 30c is provided at the surface of bipolar plate 10. Third mixture 30c covers the surface of composite sheet 11 arranged outermost in the direction of stack among the plurality of composite sheets 11. As shown in FIG. 10, third mixture 30c is a mixture containing a plurality of conductive particles 31 and resin binder 32. Third mixture 30c is formed in layers of the mixture. Third mixture 30c is not filled in pores 24 in resin sheet 20 but exposed at the surface of resin sheet 20.

Third mixture 30c may be the same as or different from first mixture 30a or second mixture 30b. In the modification, first mixture 30a, second mixture 30b, and third mixture 30c are the same mixture. In other words, the material for conductive particles 31 and the material for resin binder 32 contained in first mixture 30a, second mixture 30b, and third mixture 30c are the same. The content of conductive particles 31 in first mixture 30a, the content of conductive particles 31 in second mixture 30b, and the content of conductive particles 31 in third mixture 30c are substantially the same. When a ratio between the content of conductive particles 31 in first mixture 30a and the content of conductive particles 31 in second mixture 30b, a ratio between the content of conductive particles 31 in first mixture 30a and the content of conductive particles 31 in third mixture 30c, and a ratio between the content of conductive particles 31 in second mixture 30b and the content of conductive particles 31 in third mixture 30c are each within a range not smaller than 0.9 and not larger than 1.1, the content of conductive particles 31 is regarded as being substantially the same. The content of resin binder 32 in first mixture 30a, the content of resin binder 32 in second mixture 30b, and the content of resin binder 32 in third mixture 30c are substantially the same. When a ratio between the content of resin binder 32 in first mixture 30a and the content of resin binder 32 in second mixture 30b, a ratio between the content of resin binder 32 in first mixture 30a and the content of resin binder 32 in third mixture 30c, and a ratio between the content of resin binder 32 in second mixture 30b and the content of resin binder 32 in third mixture 30c are each within a range not smaller than 0.9 and not larger than 1.1, the content of resin binder 32 is regarded as being substantially the same.

### Effects of Embodiment

Bipolar plate 10 according to the embodiment is excellent in mechanical strength because resin sheet 20 functions as the reinforcement material. In particular, since the structure is such that resin sheets 20 are stacked in the direction of thickness of bipolar plate 10, bipolar plate 10 has a property of being strong against bending and less likely to break.

Furthermore, in bipolar plate 10 according to the modification, adjacent composite sheets 11 are readily joined to each other with first mixture 30a. In bipolar plate 10 according to the modification, the surface of bipolar plate 10 is composed of third mixture 30c. In other words, the surface portion of bipolar plate 10 does not include resin sheet 20. Therefore, the conductivity of the surface of bipolar plate 10 improves.

### <Method of Manufacturing Bipolar Plate>

Bipolar plate 10 in the embodiment can be manufactured, for example, with a manufacturing method including steps below. The method of manufacturing the bipolar plate includes steps of making a stack in which a sheet of a conductive compound and a resin sheet are alternately stacked and pressing the stack.

### (Step of Making Stack)

The sheet of the conductive compound can be made by using a mixture of a plurality of conductive particles and a resin binder as a source material and forming the source material into a sheet. The sheet of the conductive compound should only be formed, for example, with the use of an extruder. The stack is made by alternately stacking a necessary number of sheets of the conductive compound and a necessary number of resin sheets.

### (Step of Pressing Stack)

The stacked composite sheets are joined by pressing in the direction of stack while the stack is heated. For example, the stack is placed in a mold and pressed while the mold is heated to heat the stack. A heating temperature during pressing is set to a temperature not lower than a melting temperature of the resin binder contained in the sheet of the conductive compound. As the resin binder is molten, the inside of the resin sheet is filled with the conductive particles together with the molten resin binder. As the stack is cooled after it is pressed, the bipolar plate in which the plurality of composite sheets are stacked is obtained. As the molten resin binder is cooled and solidified, the conductive particles can be fixed to the resin sheet and the adjacent composite sheets can be joined to each other. The mixture that makes up the sheet of the conductive compound makes up the first mixture, the second mixture, and the third mixture described above when the bipolar plate is completed.

In order to maintain the shape of the resin sheet, a condition for pressing is preferably set to such a heating temperature and a pressing time period as preventing melting of the resin sheet. By maintaining the shape of the resin sheet, lowering in mechanical strength of the resin sheet can be suppressed. Therefore, the resin binder is preferably lower in softening point than the resin that makes up the resin sheet. In other words, the resin that makes up the resin sheet is preferably higher in softening point than the resin binder. For example, polyethylene can be adopted for the resin binder and polypropylene can be adopted for the resin that makes up the resin sheet. In this case, the heating temperature during pressing is, for example, not lower than 150° C. and not higher than 200° C. The pressing time period is, for example, not shorter than three minutes and not longer than fifteen minutes.

### FIRST TEST EXAMPLE

A sample of the bipolar plate was made of the composite sheet.

The resin sheet and the sheet of the conductive compound were prepared. A nonwoven fabric made of polypropylene fibers was adopted for the resin sheet. The nonwoven fabric had a thickness of 0.5 mm. The thickness of the nonwoven fabric at this time was a thickness with no external force being applied, that is, in a natural state. The polypropylene fibers had an average diameter of 10 μm. Polypropylene had a melting point of 160° C.

Carbon particles and polyethylene were prepared as source materials for the conductive compound. A mixture of the carbon particles and polyethylene was formed with the use of an extruder to make the sheet of the conductive compound. The sheet of the conductive compound had a thickness of 0.5 mm. The carbon particles had an average particle size of 20 μm. Polyethylene had a melting point of 130° C. An area of the sheet of the conductive compound was the same as an area of the nonwoven fabric adopted for the resin sheet.

The stack was made by alternately stacking the nonwoven fabric made from the polypropylene fibers and the sheet of the conductive compound. Combination of one nonwoven fabric and one sheet of the conductive compound was defined as one layer, and ten layers were stacked.

The mass ratio of the nonwoven fabric, the mass ratio of the carbon particles, and the mass ratio of polyethylene were adjusted to achieve the mass ratios shown in Table 1. In a first test example, the mass ratio of the nonwoven fabric was adjusted by varying the porosity of the nonwoven fabric. For samples No. 1 to No. 3, the mass ratio of each of the carbon particles and polyethylene that made up the sheet of the conductive compound was adjusted to set the mass ratio of polyethylene in the entire bipolar plate to 30 mass %. For samples No. 4 to No.7, the mass ratio of each of the carbon particles and polyethylene that made up the sheet of the conductive compound was adjusted to set the mass ratio of polyethylene in the entire bipolar plate to 20 mass %.

The bipolar plate was made by placing the obtained stack in a mold and pressing the stack. The heating temperature during pressing was set to 150° C. The pressing time period was set to ten minutes. A pressing pressure was set to 40 MPa. The obtained bipolar plate was punched into a prescribed size to obtain the bipolar plates as samples No. 1 to No. 7.

The bipolar plates as samples No. 1 to No. 7 each had a thickness of 3 mm. The bipolar plates as samples No. 1 to No. 7 each had an area of 6000 mm². For the bipolar plates as samples No. 1 to No. 7, the cross-section cut along the direction of thickness of the bipolar plate was observed with a microscope. Then, the bipolar plate had a structure in which the composite sheets were stacked in the direction of thickness of the bipolar plate. Ten composite sheets were stacked. The composite sheet included the nonwoven fabric which was the resin sheet and the second mixture filled in pores in the nonwoven fabric. The bipolar plates as all samples included the first mixture between the resin sheets and the third mixture at the surface of the bipolar plate as in the modification shown in FIGS. 7 to 10. The first mixture, the second mixture, and the third mixture were composed of the carbon particles and polyethylene that made up the sheet of the conductive compound.

For comparison, a bipolar plate composed of plastic carbon was made by forming a mixture of carbon particles and polyethylene. The mass ratio of the carbon particles and the mass ratio of polyethylene were adjusted to achieve the mass ratios shown in Table 1. This bipolar plate was defined as sample No. 10. The bipolar plate as sample No. 10 did not include the nonwoven fabric as the resin sheet. The bipolar plate as sample No. 10 had a thickness of 3 mm. An area of the bipolar plate as sample No. 10 was the same as the area of the bipolar plate as each of samples No. 1 to No. 7.

The mechanical strength and the conductivity of the bipolar plate were evaluated for each sample. Bending strength and tensile strength were evaluated as the mechanical strength. The volume resistivity was evaluated as the conductivity. Table 1 shows results thereof.

The bending strength of the bipolar plate was measured in accordance with JIS K7171:2016. The bending strength was measured in the three-point bending test. A specimen was stored for twelve hours in a constant-temperature constant-humidity bath set to a temperature of 23° C. and a relative humidity of 50% in accordance with JIS K7100: 1999. The specimen had a size of 10 mm width×80 mm long. A distance between fulcrums was set to 64 mm. A pressure bar having a diameter of 10 mm was moved down at a rate of 20 mm/minute to apply a load to a central portion of the specimen and maximum load P (N) was measured. Tensilon RTE-1210 manufactured by Orientec Co., Ltd. was employed as a measurement apparatus. The tensile strength of the bipolar plate was measured in accordance with JIS K7161:2014. The specimen had a size as large as JIS No. 3 dumbbell. Tensilon RTE-1210 manufactured by Orientec Co., Ltd. was employed as the measurement apparatus. The tensile test was conducted under a condition of a pulling speed of 5 mm/min.

The volume resistivity of the bipolar plate was measured with four-terminal sensing. Digital multimeter DME 1600 manufactured by Kikusui Electronics Corp. was employed as a measurement apparatus. The specimen had a size of 50 mm wide×50 mm long. The measured volume resistivity was a volume resistivity in the plane direction of the bipolar plate.

TABLE 1

| Sample No. | 1 | 2 | 3 | 4 | 5 | 6 | 7 | 10 |
|---|---|---|---|---|---|---|---|---|
| Mass Ratio of Non-Woven | 2 | 4 | 8 | 10 | 12 | 15 | 20 | — |
| Fabric (Mass %) | | | | | | | | |
| Mass Ratio of Carbon Particles | 68.6 | 67.2 | 64.4 | 63.0 | 61.6 | 59.5 | 56.0 | 70.0 |
| (Mass %) | | | | | | | | |
| Mass Ratio of Polyethylene | 29.4 | 28.8 | 27.6 | 27.0 | 26.4 | 25.5 | 24.0 | 30.0 |
| (Mass %) | | | | | | | | |
| Bending Strength (MPa) | 0.3 | 1.3 | 2.8 | 3.0 | 3.1 | 3.6 | 4.5 | 0.2 |
| Tensile Strength (MPa) | 1 | 8 | 20 | 20 | 21 | 23 | 30 | 0.6 |
| Volume Resistivity in Plane | 0.07 | 0.12 | 0.23 | 0.30 | 0.32 | 0.83 | 1.76 | 0.05 |
| Direction (Ω · cm) | | | | | | | | |

It can be seen in results shown in Table 1 that the bipolar plates as samples No. 1 to No. 7 having the structure in which the composite sheets were stacked were higher in bending strength and tensile strength and better in mechanical strength than the bipolar plate as sample No. 10 made of plastic carbon. The reason why samples No. 1 to No. 7 were higher in mechanical strength than sample No. 10 may be because the nonwoven fabric included in the composite sheet functioned as the reinforcement material.

It can be seen in the results shown in Table 1 that, as the mass ratio of the nonwoven fabric was higher, the bending strength and the tensile strength were higher and the mechanical strength improved. For example, it can be seen that samples No. 2 to No. 7 satisfied the bending strength not lower than 0.5 MPa and the tensile strength not lower than 2.0 MPa and additionally satisfied the bending strength not lower than 1.0 MPa and the tensile strength not lower than 6.0 MPa and had excellent mechanical strength. In particular, samples No. 3 to No. 7 achieved the bending strength not lower than 2.0 MPa and the tensile strength not lower than 20 MPa and were better in mechanical strength. It can be seen, on the other hand, that, as the mass ratio of the nonwoven fabric was lower, the volume resistivity in the plane direction was higher and conductivity improved. For example, it can be seen that samples No. 1 to No. 6 satisfied the volume resistivity in the in-plane direction not higher than 1.5 Ω·cm and additionally not higher than 1.0 Ω·cm and achieved excellent conductivity. In particular, samples No. 1 to No. 5 had the volume resistivity in the plane direction not higher than 0.5 Ω·cm and were better in conductivity. Samples No. 2 to No. 5 were better in balance between the mechanical strength and the conductivity than samples No. 1 and No. 6.

In addition, the liquid impermeability of the bipolar plate was evaluated for all samples from No. 1 to No. 7. Consequently, all samples could have ensured liquid impermeability. The liquid impermeability was evaluated as below. A battery cell for a test was constructed of the bipolar plate as each sample. A charging and discharging test was conducted for the battery cell for the test and a normal operation of the battery cell was checked. When the battery cell normally operated in the charging and discharging test, the bipolar plate was evaluated as having the liquid impermeability.

### REFERENCE SIGNS LIST

1 RF battery
2 cell stack
10 bipolar plate
11 composite sheet
20 resin sheet, 22 resin fiber, 24 pore
30a first mixture, 30b second mixture, 30c third mixture
31 conductive particle, 32 resin binder
7 AC/DC converter, 71 transformer facility
8 power generator, 9 load
100 battery cell
101 membrane, 102 positive cell, 103 negative cell
104 positive electrode, 105 negative electrode
106 positive electrolyte tank, 107 negative electrolyte tank
108, 109 supply pipe, 110, 110 return pipe
112, 113 pump
120 cell frame
122 frame body, 122r recess
123, 124 liquid supply manifold, 125, 126 liquid discharge manifold
123s, 124s liquid supply slit, 125s, 126s liquid discharge slit
127 sealing member
200s sub stack
210 end plate, 220 supply/drainage plate, 230 fastening mechanism

1. A bipolar plate used in a redox flow battery, the bipolar plate comprising:
a plurality of composite sheets; and
a first mixture that joins to each other, the composite sheets that are stacked, wherein
each of the plurality of composite sheets includes
a resin sheet including a plurality of pores, and
a second mixture filled in at least some of the plurality of pores in the resin sheet, and
each of the first mixture and the second mixture contains
a plurality of conductive particles, and
a resin binder that fixes the plurality of conductive particles to the resin sheet.

2. The bipolar plate according to claim 1, wherein
a mass ratio of the resin sheet is not lower than 3 mass % and not higher than 15 mass %.

3. The bipolar plate according to claim 1, wherein
the first mixture is arranged between the resin sheets of adjacent composite sheets.

4. The bipolar plate according to claim 1, comprising a third mixture that makes up a surface of the bipolar plate, wherein
the third mixture contains
a plurality of conductive particles, and
a resin binder that fixes the plurality of conductive particles to the resin sheet.

5. The bipolar plate according to claim 1, wherein
the resin sheet includes a plurality of resin fibers.

6. The bipolar plate according to claim 5, wherein the resin sheet is a nonwoven fabric or a woven fabric.

7. The bipolar plate according to claim 5, wherein the plurality of resin fibers include polypropylene fibers.

8. The bipolar plate according to claim 1, wherein
at least seven composite sheets are stacked.

9. The bipolar plate according to claim 1, wherein
the resin sheet has a thickness not smaller than 0.1 mm and not larger than 2 mm.

10. The bipolar plate according to claim 1, wherein
the bipolar plate has a thickness not smaller than 2 mm and not larger than 10 mm.

11. The bipolar plate according to claim 1, wherein
the bipolar plate has bending strength not lower than 0.5 MPa.

12. A cell frame comprising the bipolar plate according to claim 1.

13. A cell stack comprising the cell frame according to claim 12.

14. A redox flow battery comprising the cell stack according to claim 13.
